(19) United States
(12) Patent Application Publication
(10) Pub. No.: US 2006/0146386 A1
(43) Pub. Date: Jul. 6, 2006

(54) Hologram recording apparatus and hologram recording method

(75) Inventors: Hisayuki Yamatsu, Tokyo (JP); Nobuhiro Kihara, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/294,546

(22) Filed: Dec. 6, 2005

(30) Foreign Application Priority Data
Dec. 7, 2004 (JP) 2004-353677

(51) Int. Cl. G03H 1/30

(52) U.S. Cl. 359/25; 359/24

(57) ABSTRACT

A hologram recording apparatus and method is disclosed by which the recording density in hologram recording by shift multiple hologram recording which uses reference light of a spherical wave or by speckle multiple hologram recording which uses randomly modulated reference light can be enhanced. When interference fringes of a reference light beam and a signal light beam, for example, of spherical waves are multiple recorded in accordance with a shift multiple recording method in a hologram medium, every time a hologram train to be produced successively by shift multiplex recording the interference fringes in the hologram medium is changed, the incidence angle at which the reference light beam enters the hologram medium is changed to a different value so that a predetermined condition may be satisfied. Then, a next track is recorded using the reference light beam.

### CROSS REFERENCES TO RELATED APPLICATIONS

The present invention contains subject matter related to Japanese Patent Application JP 2004-353677 filed with the Japanese Patent Office on Dec. 7, 2004, the entire contents of which being incorporated herein by reference.

### BACKGROUND OF THE INVENTION

This invention relates to a hologram recording apparatus and method for recording interference fringes of a signal light beam and a reference light beam in a program medium, and more particularly to enhancement in recording density in a hologram medium according to a shift multiple method.

Volume hologram recording is performed such that a light intensity distribution of interference fringes appearing when a reference light and a signal light are introduced into a hologram medium having a thickness sufficiently greater than the wavelength of the reference light beam and the signal light beam and interfere with each other in the hologram medium is recorded. The volume program recording attracts attention due to a great potential recording capacity originating from volume recording and a high data transfer rate arising from batch writing/reading of a plurality of data bits. Therefore, efforts are made to investigate and develop the volume hologram recording.

Generally, in the volume hologram recording, multiple recording wherein a large number of holograms are recorded at the same portion of a medium is applied to achieve a high recording density. Various methods have been proposed for multiple recording such as angle multiple, phase multiple and speckle multiple, and examinations are made to make the most of the characteristics of the individual methods. Of such various multiple recording methods as mentioned above, the shift multiple recording which uses a spherical wave does not include any movable element in an optical system thereof and allows recording while a medium is rotationally moved with respect to the optical system every time a hologram is recorded. Consequently, the shift multiple recording is congenial with a disk-type medium and has a comparatively high stability in recording and reproduction. Therefore, attention is paid to a hologram recording medium as an optical memory which replaces existing optical disks.

Here, it is assumed that an in-plane direction defined by a reference light beam and a signal light beam is referred to as in-track direction and a direction perpendicular to the in-track direction is referred to as cross-track direction. In the in-track direction, it is generally possible to implement a shift selectivity of approximately several μm to several tens μm and achieve a high recording density. The shift selectivity above is an index representing a “distance over which a medium and a recording spot should be moved relative to each other in order to allow a next hologram to be recorded after a certain hologram is recorded”. In particular, the reproduction intensity of the hologram is measured with respect to the amount of relative movement between the reproduction spot and the medium and is plotted as a graph.

### SUMMARY OF THE INVENTION

However, with the conventional shift multiple recording which uses spherical wave reference light, although a favorable shift selectivity is obtained in the in-track direction as described above, generally the selectivity in the cross-track direction is very low, and it is necessary to record adjacent holograms in a spaced relationship by more than several hundreds μm from each other. This arises from the fact that, since the signal light beam and the reference light beam intersect with each other at an angle of almost 0 degree in the cross-track direction, the Bragg selectivity is very low. Accordingly, the recording density in the cross-track direction is as low as one several tenth to one several hundredth that in the in-track direction. As a result, there is a problem that it is difficult to enhance the recording density as a whole. On the other hand, with the speckle multiple method which uses randomly modulated reference light, also the shift selectivity in the cross-track direction is high, and a recording density much higher than that of the shift multiple method which uses reference light of a spherical wave can be achieved. However, also with the speckle multiple method, it is a preferable subject to achieve further enhancement of the recording density.

It is an object of the present invention to provide a hologram recording apparatus and a hologram recording method by which the recording density in hologram recording by shift multiple hologram recording which uses reference light of a spherical wave or by speckle multiple hologram recording which uses randomly modulated reference light can be enhanced.

In order to attain the object described above, according to the present invention, when interference fringes of a reference light beam and a signal light beam, for example, of spherical waves are multiple recorded in accordance with a shift multiple recording method in a hologram medium, every time a hologram train to be produced successively by shift multiplex recording the interference fringes in the hologram medium is changed, the incidence angle at which the reference light beam enters the hologram medium is changed to a different value so that a predetermined condition may be satisfied.

In particular, according to the present invention, there is provided a hologram recording apparatus for multiple recording interference fringes of a reference light beam and a signal light beam in a hologram medium in accordance with a shift multiple method, comprising an incidence angle variation unit configured to vary the incidence angle at which the reference light beam enters the hologram medium, and a controller configured to control when a hologram train to be produced successively by shift multiple recoding the interference fringes in the hologram medium is changed, the incidence angle variation unit to change the incidence angle into a different value.

The angle difference between two arbitrary ones of a plurality of incidence angles having different values from each other may be greater than and equal to an angle difference with which wave fronts of two reference light beams having the two different incidence angles do not coincide with each other in what manner the two reference light beams are parallelly moved spatially.

Or, the angle difference between two arbitrary ones of a plurality of incidence angles having different values from each other may be greater than an angle selectivity which the hologram recording apparatus has.

Or else, the angle difference between two arbitrary ones of a plurality of incidence angles having different values from each other may be greater than and equal to an angle difference with which, upon reproduction of a hologram recorded with the reference light beam having a first incidence angle and the signal light beam, reproduction light from another hologram recorded with the reference light beam having a second incidence angle and the signal light does not enter a reproduction light detector.

In the hologram recording apparatus, when interference fringes of a reference light beam and a signal light beam, for example, of spherical waves are multiple recorded in accordance with a shift multiple recording method in a hologram medium, every time a hologram train to be produced successively by shift multiplex recording the interference fringes in the hologram medium is changed, the incidence angle at which the reference light beam enters the hologram medium is changed into a different value. In this instance, where the angle difference between two reference light beams having such different incidence angles from each other is greater than the angle difference with which wave fronts of the two reference light beams do not coincide with each other in what manner the two reference light beams are parallelly moved spatially, then two hologram trains can be recorded or reproduced without crosstalk therebetween. Accordingly, if, after recording of two hologram trains is completed, a different hologram train is recorded between the two hologram trains with the incidence angle of the reference light beam changed, then the recording density by shift multiple recording using the reference light beam of a spherical wave can be increased to twice.

The advantage just described can be achieved also where the angle difference between two arbitrary ones of a plurality of incidence angles having different values from each other is greater than an angle selectivity which the hologram recording apparatus has or alternatively is greater than and equal to an angle difference with which, upon reproduction of a hologram recorded with the reference light beam having a first incidence angle and the signal light beam, reproduction light from another hologram recorded with the reference light beam having a second incidence angle and the signal light does not enter a reproduction light detector.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a configuration of a hologram recording apparatus according to a first embodiment of the present invention;

FIG. 2 is a schematic view showing a modulation pattern displayed on a spatial modulator shown in FIG. 1;

FIGS. 3A and 3B are schematic views showing details of a reference light medium incidence angle variation unit used in the hologram recording apparatus of FIG. 1;

FIGS. 4A to 4C are diagrammatic views illustrating a relationship between a hologram recording order by the hologram recording apparatus of FIG. 1 and the incidence angle of a reference light beam;

FIGS. 5A to 5C are schematic views illustrating an angle difference to be assured between incidence angles of reference light beams;

FIG. 6 is a block diagram showing a configuration of part of a hologram recording apparatus according to a second embodiment of the present invention;

FIGS. 7A and 7B are block diagrams showing a configuration of part of a hologram recording apparatus according to a third embodiment of the present invention; and

FIGS. 8A to 8C are block diagrams showing a configuration of part of a hologram recording apparatus according to a fourth embodiment of the present invention.

### DETAILED DESCRIPTION OF THE PREFERRED EMBODIMENTS

### First Embodiment

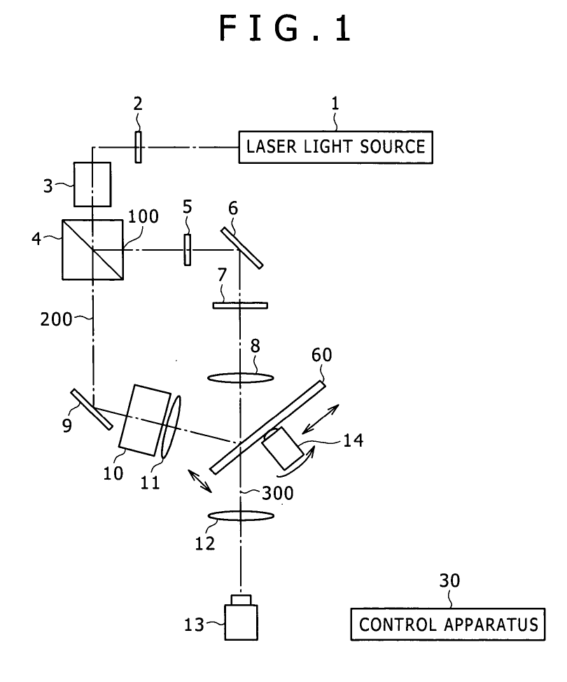

Referring first to FIG. 1, there is shown a configuration of a hologram recording apparatus according to a first embodiment of the present invention. The hologram recording apparatus (including also a reproduction system) includes a laser light source 1, a pair of shutters 2 and 5, a beam expander 3, a beam splitter 4, a mirror 6, a spatial modulator 7, and a signal light lens 8. The hologram recording apparatus further includes a hologram medium 60 in the form of a disk made of a photo-polymer material or the like, another mirror 9, a reference light medium incidence angle variation optical system 10, a reference light lens 11, and a reproduction light lens 12. The hologram recording apparatus further includes a detector 13 which may be formed from a CCD image sensor or a CMOS image sensor, a spindle motor 14 for rotating and translating the hologram medium 60, and a control apparatus 30 for controlling recording and reproduction actions of the hologram recording apparatus. The control apparatus 30 controls a displaying action of the spatial modulator 7, opening and closing actions of the shutters 2 and 5, an angle variation action of the reference light medium incidence angle variation optical system 10 and so forth.

It is to be noted that the reference light medium incidence angle variation optical system 10 and the reference light lens 11 are shown in a configuration expedient for the explanation of general action of the hologram recording apparatus. As hereinafter described, various configurations are available, and two or more reference light lenses 11 may be provided occasionally.

Different from conventional hologram recording apparatus, in the hologram recording apparatus of the present embodiment, the reference light medium incidence angle variation optical system 10 is inserted in the optical path of a reference light beam 200 so that the incidence angle of the reference light beam 200 to the hologram medium 60 can be varied. Further, although any laser light source can be used for the laser light source 1 only if it generates a laser beam having a coherence length of several cm or more with which hologram recording is possible, it preferably has a wavelength which is within a visible wavelength region to which the hologram medium 60 generally has a sensitivity, above all, within a range from approximately 400 to 700 nm.

Action of the hologram recording apparatus of the present embodiment is described. In order to record data into the hologram medium 60, while the shutter 2 is in a closed state (during recording, the shutter 5 normally remains open) and a data page to be recorded is displayed on the spatial modulator 7 which may be a liquid crystal display apparatus of the transmission type, the spindle motor 14 is rotated to determine a recording place (recording area) of the hologram medium 60, whereafter the shutter 2 is opened.

Consequently, a laser beam emitted from the laser light source 1 and having coherence passes through the shutter 2 and enters the beam expander 3, by which it is expanded until it has a beam diameter sufficient to fully cover a modulation region of the spatial modulator 7. Thereafter, the laser beam enters the beam splitter 4, by which it is split into a recording light beam 100 and a reference light beam 200. The reference light beam 200 is diverted by the mirror 9 to change its advancing direction and irradiated on the hologram medium 60 through the reference light medium incidence angle variation optical system 10 and the reference light lens 11. Here, the incidence angle (medium incidence angle) of the reference light beam 200 to the hologram medium 60 is varied in accordance with a control instruction from the control apparatus 30 by the reference light medium incidence angle variation optical system 10.

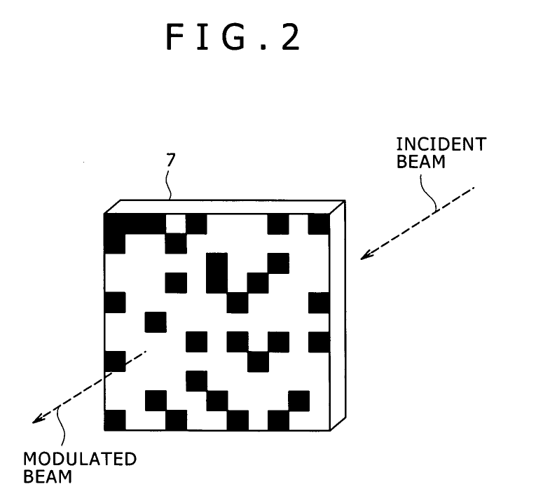

Meanwhile, the recording light beam 100 is introduced into the spatial modulator 7 through the mirror 6 and is spatially modulated (amplitude modulated) by the spatial modulator 7 while it passes through the spatial modulator 7 on which a data page is displayed. The spatial modulator 7 may be formed, for example, from a liquid crystal display unit and vary the transmission factor of a large number of pixels independently of each other to produce such a spatial modulation pattern as shown in FIG. 2. The spatially modulated recording light beam 100 is irradiated through the signal light lens 8 so that it may overlap with the reference light beam 200 in the hologram medium 60. The reference light beam 200 and the recording light beam 100 irradiated into the hologram medium 60 interfere with each other in the hologram medium 60, and a light intensity distribution of interference fringes generated by the interference is recorded as a hologram in the hologram medium 60. Thereafter, the shutter 2 is closed.

The hologram recorded here may be a real image displayed on the spatial modulator 7 by the signal light lens 8 or may otherwise be a Fourier transform image of the real image of the spatial modulator 7. However, a method wherein a Fourier transform image is recorded is used popularly because the size per one hologram can be reduced comparatively readily and the Fourier transform image is less likely to be influenced by a defect which appears in the hologram medium 60.

Then, if a data page to be recorded next is displayed on the spatial modulator 7 and the spindle motor 14 rotates a little to move the hologram medium 60 by δ, then the place at which the recording light beam 100 and the reference light beam 200 are focused relatively moves by δ. If the shutter 2 is opened in this state, then the data page to be recorded next is recorded as a hologram at the focused region (recording area) of the recording light beam (ray) 100 and the reference light beam (ray) 200.

In order to reproduce the hologram recorded in such a manner as described above, while the shutter 5 remains closed, the shutter 2 is opened, whereupon the reference light beam 200 is irradiated at the position at which the hologram is recorded. Hologram reproduction light 300 generated by the irradiation of the reference light beam 200 is focused by the reproduction light lens 12 to form an image on the detector 13. Usually, a CCD or CMOS image sensor including a large number of pixels disposed two-dimensionally thereon is used for the detector 13, and decoding of such a modulation pattern as shown in FIG. 2 is performed by analyzing the intensity of light incident to each of the pixels of the detector 13.

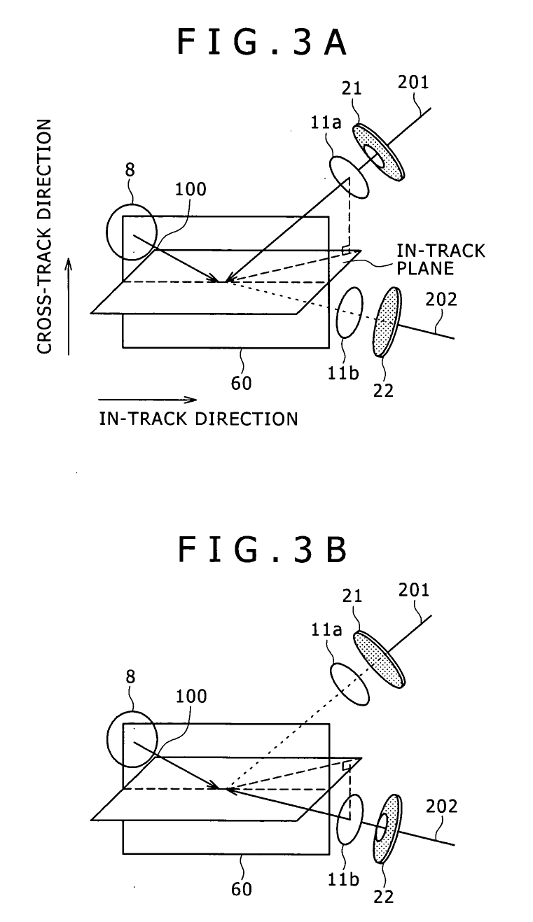

In the following, details of a characteristic portion of the hologram recording apparatus of the present embodiment are described. Referring to FIGS. 3A and 3B, the reference light medium incidence angle variation optical system 10 includes two independent reference light lenses 11a and 11b for receiving two reference light beams 201 and 202, and two shutters 21 and 22 inserted in optical paths of the reference light beams 201 and 202 from the reference light lenses 11a and 11b, respectively. It is to be noted that the in-track plane in FIGS. 3A and 3B is an imaginary plane perpendicular to the hologram medium 60, which is introduced in FIGS. 3A and 3B in order to facilitate understandings of the figures, and the in-track direction is given by the direction of a nodal line between the in-track plane and the hologram medium 60. The in-track direction is a direction in which the medium is to be shifted principally upon recording and coincides, where the medium is a disk medium, with the direction of rotation of the disk.

The reference light beam 200 is diverted by the mirror 9 of FIG. 1 to change its advancing direction and then split into two beams by the beam splitter not shown. The two beams of the reference light beam 200 are introduced separately into the reference light lenses 11a and 11b and enter the hologram medium 60 at different incidence angles from each other. The upper side one of the two beams of the reference light beam 200 in FIGS. 3A and 3B is referred to as reference light beam 201 while the lower side beam of the reference light beam 200 is referred to as reference light beam 202.

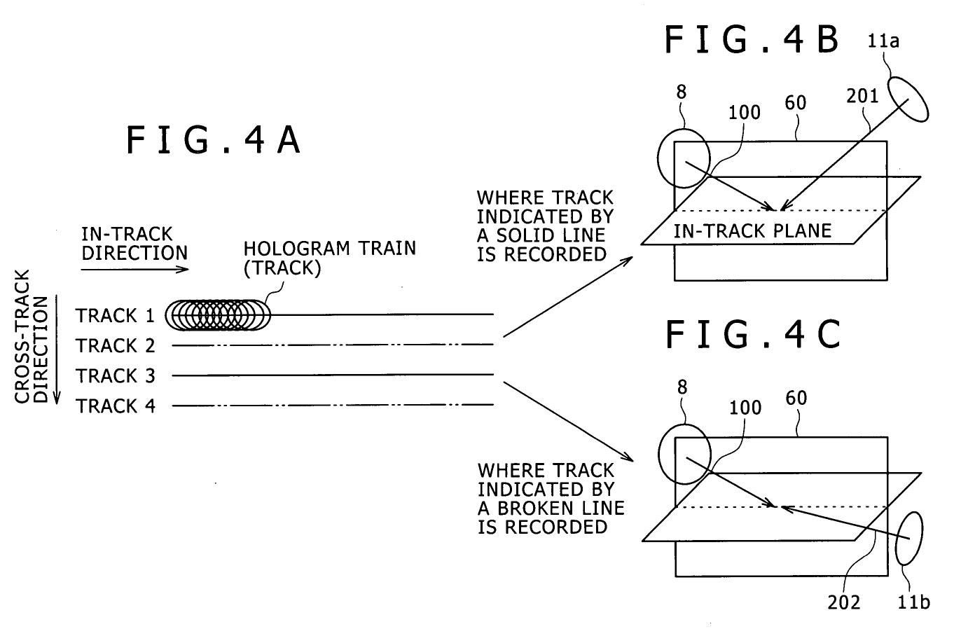

Referring to FIG. 3A, the reference light shutter 21 is opened first to establish a condition wherein only the reference light beam 201 can be irradiated on the hologram medium 60 as seen in FIG. 4B. Then, a hologram train is shift multiple recorded as seen in FIG. 4A. In the following description, such a multiple recorded hologram train is referred to as track. After recording of a certain track is completed, the control apparatus 30 issues an instruction to a feeding mechanism not shown to shift the hologram medium 60 in a direction (cross-track direction) perpendicular to the track together with the spindle motor 14. Simultaneously, the control apparatus 30 controls so that the reference light shutter 21 is closed and the reference light shutter 22 is opened to establish a condition wherein only the reference light beam 202 can be irradiated on the hologram medium 60 as seen in FIG. 4C. Then, a next track is shift multiple recorded. Thereafter, holograms are recorded successively by using only one of two reference light beams such that the reference light beam to be used for recording is changed over alternately every time the track changes. Naturally, it is otherwise possible not to change over the reference light beam, which is to be used for recording, alternately between different tracks but to record holograms first over the overall area of the disk using the reference light beam 201 and then record holograms over the overall area of the disk using the other reference light beam 202.

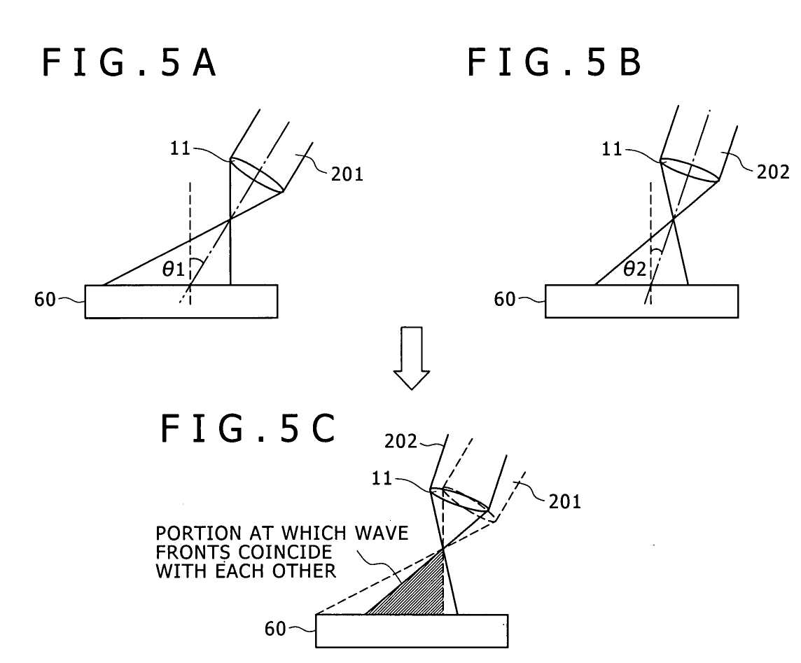

It is necessary to keep, between the medium incidence angles of the reference light beam 201 and the reference light beam 202, the difference with which, in what manner at least one of the two reference light beams is parallelly moved spatially, it does not coincide with the remaining reference light wave front at all. FIGS. 5A to 5C illustrate different cases wherein the wave fronts of the reference light beam 201 and the reference light beam 202 partly coincide with each other. In particular, FIGS. 5A and 5B illustrate examples wherein the incidence angles of the reference light beams 201 and 202 to the hologram medium 60 are θ1 and θ2, respectively, and illustrate that, with such incidence angles as just mentioned, the wave fronts of the reference light beams 201 and 202 partially coincide with each other as seen in FIG. 5C. This phenomenon appears when the condition described above is not satisfied, and when one of the reference light beams is shifted spatially, the wave front of the reference light beam partially coincides with the wave front of the other reference light beam as seen in FIG. 5C. This gives rise to the possibility that, upon reproduction of a hologram recorded using each one of the reference light beams, the hologram may suffer from crosstalk from an adjacent hologram recorded using the other reference light beam. If the condition described hereinabove is satisfied and besides the difference between the medium incidence angles of the different reference light beams is greater than and equal to the angle selectivity of the system, then upon reproduction of a hologram recorded using one of the reference light beams, a hologram recorded using the other reference light beam is not reproduced, and accordingly, no crosstalk occurs.

Where the angle selectivity is extremely loose such as where the thickness of the hologram medium is very small, it may possibly be difficult to provide an angle difference greater than and equal to the angle selectivity of the system between the incidence angles of the two reference light beams. In such an instance, occurrence of crosstalk can be prevented actually if the medium incidence angle difference between the reference light beams at least upon reproduction of a hologram using one of the reference light beams is so great that reproduction light from a hologram recorded using the other reference light beam does not enter the detector 13. It is to be noted that hologram reproduction light reproduced using a reference light beam of an incidence angle different from that used upon recording advances in a direction different from that of the original signal light.

With the hologram recording apparatus according to the present embodiment, where two reference light beams are used, for example, if it is assumed that the intersecting angle between the reference light beam 201 and the recording light beam 100 and the intersecting angle between the reference light beam 202 and the recording light beam 100 are equal to each other, then the recording density can be raised to twice when compared with that achieved by a conventional spherical wave shift multiple recording method which uses a set of a reference light beam and a signal light beam which intersect with an equal intersecting angle.

The foregoing description is directed to the shift multiple recording wherein two reference light beams are used alternately for recording. If a reference light beam is split into N beams which are irradiated at different incidence angles on a hologram medium using N independent lenses such that the same one reference light beam is used for recording in the same track and, every time the track to be recorded is changed over, the reference light beam to be used for recording is changed, then the recording density can be raised to N times that achieved by the conventional method.

### Second Embodiment

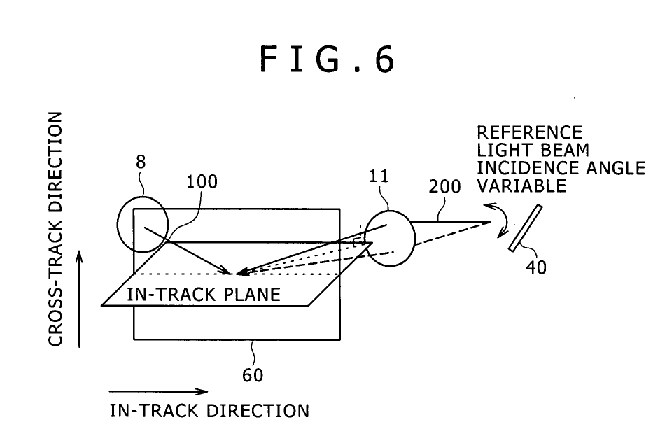

FIG. 6 shows a configuration of part of a hologram recording apparatus according to a second embodiment of the present invention. The hologram recording apparatus of the present embodiment is a modification to but is different from the hologram recording apparatus of the first embodiment described hereinabove in the configuration of the reference light medium incidence angle variation optical system. In particular, the reference light medium incidence angle variation optical system in the hologram recording apparatus of the present invention includes, for example, a tilt angle variation mirror 40 which varies the reference light incidence angle to the reference light lens 11 to vary the incidence angle of the reference light beam 200 to the hologram medium 60.

Now, action of the hologram recording apparatus of the present embodiment is described. First, a reference light beam is fixed at a certain medium incidence angle condition, and one track is shift multiple recorded. After the recording of the track comes to an end, the control apparatus 30 controls the hologram medium 60 to be shifted in a cross-track direction together with the spindle motor 14. Simultaneously, the control apparatus 30 controls the movable mirror to vary the incidence angle of the reference light beam to the reference light lens 11 thereby to vary the incidence angle (medium incidence angle) of the reference light beam to the hologram medium 60. At this time, between the medium incidence angle of a reference light beam used for recording first and the medium incidence angle of the new reference light beam, an angle difference is provided in advance with which, in what manner at least one of the two reference light beams is parallelly moved spatially, the wave front thereof does not coincide with the wave front of the other reference light beam. In this condition, a next track is shift multiple recorded. Thereafter, the medium incidence angle of the reference light beam to be used for recording is changed over similarly every time the track changes to successively record holograms.

With the hologram recording apparatus of the present embodiment, since only one reference light lens 11 is required, the scale of the reference light optical system can be reduced from that in the hologram recording apparatus of the first embodiment, and this is advantageous in miniaturization of the optical pickup. Also the advantages achieved by the hologram recording apparatus of the first embodiment are achieved by the hologram recording apparatus of the present embodiment.

It is to be noted that, where the medium incidence angle of the reference light beam in the hologram recording apparatus of the present embodiment is changed over among N stages, the recording density can be raised to N times when compared with that in the conventional arrangement wherein the medium incidence angle is fixed.

Further, if the medium incidence angles of the reference light beams have an angle difference therebetween greater than and equal to the angle selectivity of the system, then upon hologram reproduction with a certain reference light beam, crosstalk from a hologram recorded with the other reference light does not occur. Further, where the angle selectivity is extremely loose such as where the thickness of the hologram medium is very small, it may possibly be difficult to provide an angle difference greater than and equal to the angle selectivity of the system between the incidence angles of the two reference light beams. In such an instance, occurrence of crosstalk upon hologram reproduction can be prevented actually if the medium incidence angle difference between the reference light beams at least upon reproduction of a hologram using one of the reference light beams is so great that reproduction light from a hologram recorded using the other reference light beam does not enter the detector.

### Third Embodiment

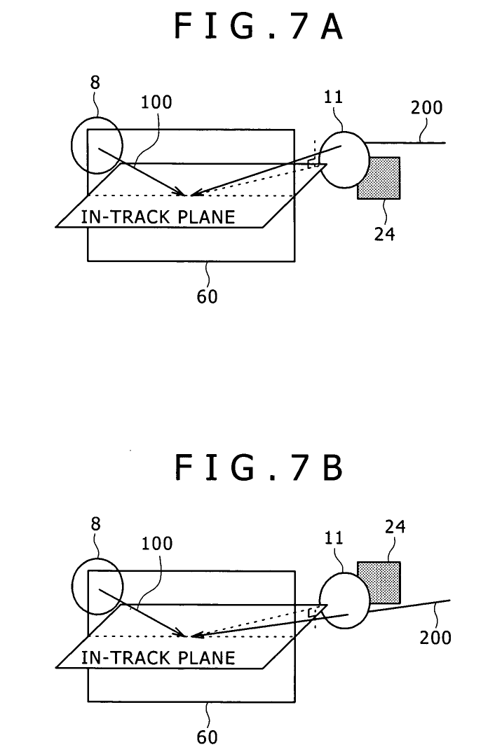

FIG. 7 shows a configuration of part of a hologram recording apparatus according to a third embodiment of the present invention. The hologram recording apparatus of the present embodiment is a modification to but is different from the hologram recording apparatus of the first embodiment described hereinabove in the configuration of the reference light medium incidence angle variation optical system 10. In particular, the reference light medium incidence angle variation optical system 10 includes a reference light lens 11 and a partial reference light lens pupil interception mask (partial light blocking mask) 24 as the reference light medium incidence angle variation optical system. Consequently, the reference light incidence angle to the reference light lens 11 is varied thereby to vary the incidence angle of the reference light beam 200 to the hologram medium 60.

The partial reference light lens pupil interception mask 24 is a light blocking mask for allowing only part of a reference light beam to enter the pupil of the reference light lens 11. The mask can be formed using, for example, a liquid crystal spatial modulator which can project an arbitrary mask pattern. Further, a plurality of mask patterns may be individually formed from metal plates which are used selectively in accordance with an object.

Now, action of the hologram recording apparatus of the present embodiment is described. Where such a certain mask pattern as shown in FIG. 7A is used as the partial reference light lens pupil interception mask 24, the reference light beam 200 enters the hologram medium 60 at a certain fixed incidence angle. Therefore, the medium incidence angle of the reference light beam 200 is fixed with a certain mask pattern to shift multiple record one track. After the recording of the track is completed, the control apparatus 30 shifts the hologram medium 60 in a cross-track direction similarly as in the hologram recording apparatus of the first and second embodiments. Simultaneously, the control apparatus 30 varies the mask pattern to that shown in FIG. 7B thereby to vary the incidence angle of the reference light beam 200 to the hologram medium 60. At this time, between the medium incidence angle of a first reference light beam used for recording and the medium incidence angle of the new reference light beam, an angle difference is provided in advance with which, in what manner at least one of the two reference light beams is parallelly moved spatially, the wave front thereof does not coincide with the wave front of the other reference light beam. Thereafter, the medium incidence angle of the reference light beam to be used for recording is changed over similarly every time the track changes to successively record holograms.

With the hologram recording apparatus of the present embodiment, since the reference light medium incidence angle variation optical system is formed simply from the partial reference light lens pupil interception mask 24 and the reference light lens 11, the configuration of the reference light optical system can be formed in a smaller size than that in the hologram recording apparatus of the first embodiment, which is advantageous in miniaturization of the optical pickup. Also the advantages achieved by the hologram recording apparatus of the first embodiment are achieved by the hologram recording apparatus of the present embodiment.

It is to be noted that, for example, if N different mask patterns are used for the partial reference light lens pupil interception mask 24 such that the medium incidence angle of the reference light beam 200 is changed over among N stages, the recording density can be raised to N times when compared with that in the conventional arrangement wherein the medium incidence angle is fixed.

Further, if the medium incidence angles of the reference light beams have an angle difference therebetween greater than and equal to the angle selectivity of the system, then upon hologram reproduction with a certain reference light beam, crosstalk from a hologram recorded with the other reference light does not occur. Further, where the angle selectivity is extremely loose such as where the thickness of the hologram medium is very small, it may possibly be difficult to provide an angle difference greater than and equal to the angle selectivity of the system between the incidence angles of the two reference light beams. In such an instance, occurrence of crosstalk upon hologram reproduction can be prevented actually if the medium incidence angle difference between the reference light beams at least upon reproduction of a hologram using one of the reference light beams is so great that reproduction light from a hologram recorded using the other reference light beam does not enter the detector.

### Fourth Embodiment

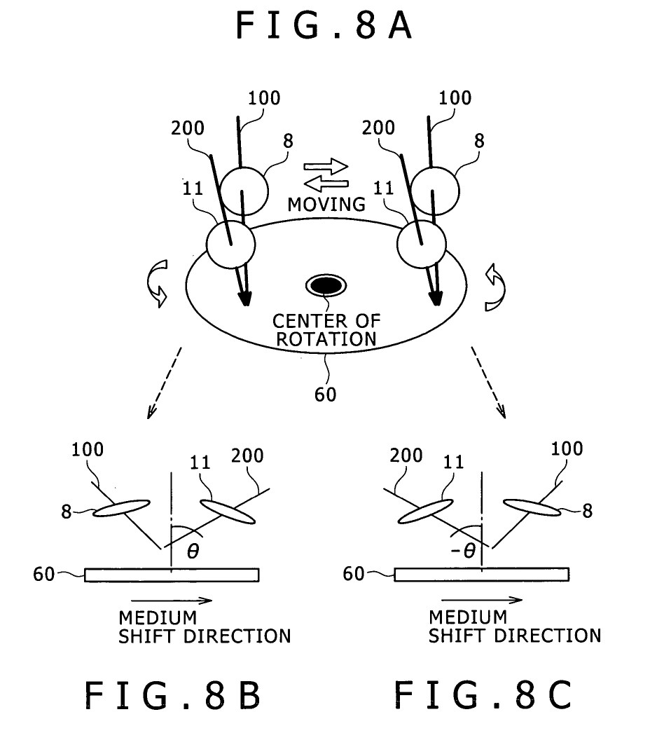

FIG. 8 shows a configuration of part of a hologram recording apparatus according to a fourth embodiment of the present invention. The hologram recording apparatus of the present embodiment has a configuration similar to that of the conventional hologram recording apparatus in that the reference light optical system does not include a reference light medium incidence angle variation optical system similarly as in the hologram recording apparatus of the first embodiment but the reference light beam 200 is introduced into the hologram medium 60 by the reference light lens 11. However, the hologram recording apparatus of the present embodiment includes a mechanism for moving the recording spot, which appears in the hologram medium 60 upon irradiation of the reference light beam 200 and the recording light beam 100, to the opposite side with respect to the center of rotation of the hologram medium 60. Naturally, a mechanism for moving the hologram medium 60 with respect to the optical system may be provided instead.

Now, action of the hologram recording apparatus of the present embodiment is described. Where the recording spot is on the left side with respect to the hologram medium 60 as seen in FIG. 8A, the reference light beam 200 has such an incidence angle to the hologram medium 60 as seen in FIG. 8B. However, if the control apparatus 30 controls the feeding mechanism to move the recording spot to the right side with respect to the hologram medium 60 as seen in FIG. 8A, then the reference light beam 200 has such an incidence angle to the hologram medium 60 as seen in FIG. 8C, which is different from the incidence angle illustrated in FIG. 8B. This is equivalent to a case wherein two reference light beams having different medium incidence angles from each other are used to record holograms with the hologram medium 60 shifted in one direction.

Also in this instance, if the two reference light beams have such a medium incidence angle difference that in what manner at least one of the reference light beams is parallelly moved spatially, the wave front thereof does not coincide with the wave front of the other reference light beam and besides the medium incidence angles of the reference light beams have an angle difference therebetween greater than and equal to the angle selectivity of the system, then upon hologram reproduction with one of the reference light beams, occurrence of crosstalk from a hologram recorded with the other reference light beam can be prevented.

With the hologram recording apparatus of the present embodiment, since the recording spot appearing on the hologram medium 60 by irradiation of the reference light beam 200 and the recording light beam 100 is moved to the opposite side with respect to the center of rotation of the medium every time the track changes, hologram recording in the hologram medium 60 can be performed with a recording density raised to twice from that in the conventional apparatus.

It is to be noted that, where the angle selectivity is extremely loose such as where the thickness of the hologram medium is very small, it may possibly be difficult to provide an angle difference greater than and equal to the angle selectivity of the system between the incidence angles of the two reference light beams. In such an instance, occurrence of crosstalk upon hologram reproduction can be prevented actually if the medium incidence angle difference between the reference light beams at least upon reproduction of a hologram using one of the reference light beams is so great that reproduction light from a hologram recorded using the other reference light beam does not enter the detector.

While preferred embodiments of the present invention have been described using specific terms, the present invention is not limited to the embodiments described above but can be carried out in various forms in terms of the particular configuration, function, action and advantage. For example, while, in the embodiments described above, the medium incidence angle of a reference light beam is changed between hologram trains to record another hologram train, if the incidence angle of the reference light beam is changed, then a new hologram train may be recorded on a hologram train recorded already. In summary, a hologram train can be written at any place of a program medium without any trouble and can be recorded and reproduced without crosstalk.

Further, while the reference light beam used in the hologram recording apparatus of the embodiments described above is a spherical wave, the present invention can be applied similarly also to a speckle wave whose wave front is disordered at random to achieve similar advantages.

What is claimed is:

1. A hologram recording apparatus for multiple recording interference fringes of a reference light beam and a signal light
beam in a hologram medium in accordance with a shift multiple method, comprising:
an incidence angle variation unit configured to vary the incidence angle at which the reference light beam enters the hologram medium; and
a controller configured to control when a hologram train to be produced successively by shift multiple recoding the interference fringes in the hologram medium is changed, said incidence angle variation unit to change the incidence angle into a different value.

2. The hologram recording apparatus according to claim 1, wherein the angle difference between two arbitrary ones of a plurality of incidence angles having different values from each other is greater than and equal to an angle difference with which wave fronts of two reference light beams having the two different incidence angles do not coincide with each other in what manner the two reference light beams are parallelly moved spatially.

3. The hologram recording apparatus according to claim 1, wherein the angle difference between two arbitrary ones of a plurality of incidence angles having different values from each other is greater than and equal to an angle selectivity which said hologram recording apparatus has.

4. The hologram recording apparatus according to claim 1, wherein the angle difference between two arbitrary ones of a plurality of incidence angles having different values from each other is greater than and equal to an angle difference with which, upon reproduction of a hologram recorded with the reference light beam having a first incidence angle and the signal light beam, reproduction light from another hologram recorded with the reference light beam having a second incidence angle and the signal light does not enter a reproduction light detector.

5. The hologram recording apparatus according to claim 1, wherein said incidence angle variation unit includes a plurality of lenses for introducing the reference light beam at different incidence angles from each other to the hologram medium, and a reference light optical path changing unit configured to select an arbitrary one of said lenses through which the reference light is to be introduced into the hologram medium.

6. The hologram recording apparatus according to claim 1, wherein said incidence angle variation unit includes a single lens for introducing the reference light into the hologram medium, and a reference light angle variation unit configured to vary the angle at which the reference light is to be introduced into said lens.

7. The hologram recording apparatus according to claim 1, wherein said incidence angle variation unit includes a single lens for introducing the reference light into the hologram medium, and a position changing unit configured to change the position of said lens at which the reference light is to pass through said lens.

8. The hologram recording apparatus according to claim 7, wherein said position changing unit is a light intercepting mask for intercepting the reference light beam so that the position of said lens at which part of the reference light beam is to pass through said lens may be changed.

9. The hologram recording apparatus according to claim 1, wherein the hologram medium is in the form of a disk, and said incidence angle variation unit includes a reference light optical system or a moving mechanism for the program medium for moving an irradiation area of the reference light beam on the hologram medium is moved to the opposite side with respect to the center of rotation of the hologram medium.

10. The hologram recording apparatus according to claim 1, wherein the reference light beam has a spherical wave or has a wave front modulated at random.

11. A hologram recording method for multiple recording interference fringes of a reference light beam and a signal light beam in a hologram medium in accordance with a shift multiple method, comprising the steps of:
shift multiple recording the interference fringes successively in the hologram medium to produce a hologram train; and
changing, when the hologram train is to be changed, the incidence angle at which the reference light beam enters the hologram medium into a different value.

12. The hologram recording method according to claim 11, wherein the angle difference between two arbitrary ones of a plurality of incidence angles having different values from each other is greater than and equal to an angle difference with which wave fronts of two reference light beams having the two different incidence angles do not coincide with each other in what manner the two reference light beams are parallelly moved spatially.

13. The hologram recording method according to claim 11, wherein the angle difference between two arbitrary ones of a plurality of incidence angles having different values from each other is greater than and equal to an angle selectivity which a system to which the hologram recording medium is applied has.

14. The hologram recording method according to claim 11, wherein the angle difference between two arbitrary ones of a plurality of incidence angles having different values from each other is greater than and equal to an angle difference with which, upon reproduction of a hologram recorded with the reference light beam having a first incidence angle and the signal light beam, reproduction light from another hologram recorded with the reference light beam having a second incidence angle and the signal light does not enter a reproduction light detector.

15. The hologram recording method according to claim 11, wherein the reference light beam has a spherical wave or has a wave front modulated at random.
